(19) United States
(12) Patent Application Publication
(10) Pub. No.: US 2016/0091363 A1
(43) Pub. Date: Mar. 31, 2016

(54) OPTICAL SENSOR

(71) Applicants: Takuma SHIRAHASHI, Tokyo (JP); Yuya KAWASAKI, Tokyo (JP); Shigeo TAMURA, Tokyo (JP)

(72) Inventors: Takuma SHIRAHASHI, Tokyo (JP); Yuya KAWASAKI, Tokyo (JP); Shigeo TAMURA, Tokyo (JP)

(73) Assignee: MITSUMI ELECTRIC CO., LTD., Tokyo (JP)

(21) Appl. No.: 14/497,765

(22) Filed: Sep. 26, 2014

(51) Int. Cl. G01J 1/02; G01J 1/04

(52) U.S. Cl. CPC G01J 1/0238; G01J 1/0488

(57) ABSTRACT

An optical sensor includes a first light-receiving element with one of a first polygonal ring shape and a first circular ring shape, a second light-receiving element with one of a second polygonal ring shape and a second circular ring shape, the second light-receiving element being provided separately from the first light-receiving element and concentrically with the first light-receiving element, and a subtraction device configured to conduct subtraction between an output from the first light-receiving element and an output from the second light-receiving element.

### BACKGROUND OF THE INVENTION

1. Field of the Invention

An aspect of the present invention relates to an optical sensor.

2. Description of the Related Art

In recent years, an illuminance sensor and a proximity sensor that are packaged in one compact package are mounted on a mobile instrument such as a mobile phone or a smartphone, for brightness adjustment and visibility improvement of a display screen depending on environmental light or electric power saving at a time of calling. These sensors are usually covered by a cover member such as a blackish cover glass that generally blocks visible light.

It is desirable for a spectral characteristic of a photodiode (PD) for an illuminance sensor to have a maximum sensitivity in a region (generally, a wavelength of 400 nm-a wavelength of 700 nm) where it is possible for a human eye to perceive brightness, and to have a low relative sensitivity in an infrared light region (generally, a wavelength of 800 nm-a wavelength of 1000 nm). A spectral characteristic of such a PD covered with a cover glass is such that a relative sensitivity in an infrared light region is high. Hence, a technique for maintaining detection precision of an illuminance sensor is known in such a manner that a relative sensitivity in an infrared light region is reduced (spectral sensitivity correction) by utilizing a PD that has a maximum sensitivity in an infrared light region (PD for spectral sensitivity correction) or the like.

As illustrated in FIG. 10, a spectral characteristic of a PD for an illuminance sensor is such that a relative sensitivity in an infrared light region in a case where covering with a cover member such as a blackish glass is provided is high as compared to a case where no covering with a cover member such as a blackish cover glass is provided.

A solar radiation sensor device is disclosed wherein arrangement or shapes of a light blocking mask and a light sensitive part or the like is/are adjusted depending on a direction of solar radiation or light incident on a light-receiving surface and a light-receiving surface area of the light sensitive part and a light-blocking surface area of the light sensitive part that is covered with the light-blocking mask are controlled, so that such solar radiation or light is detected at high efficiency (see, for example, Japanese Patent Application Publication No. 7-311084).

Furthermore, a photoelectric conversion module is disclosed wherein a plurality of light-receiving elements with different band gap energies are separately arranged on an identical substrate via an insulating layer and light that has many wavelength components is received by respective light-receiving elements so that efficient photoelectric conversion is conducted (see, for example, Japanese Patent Application Publication No. 5-206500).

In a case where a plurality of PDs that have different spectral characteristics are formed on an identical substrate, it is difficult to homogenize an amount of received light among respective PDs even when a direction of light incident on a light-receiving surface is changed.

For example, in a case where a PD for an illuminance sensor and a PD for a proximity sensor are arranged adjacently (see FIG. 11A) and a direction of incident light is changed, changes in surface areas for light that is incident on respective PDs are compared (see FIG. 11B). As surface areas for light that is incident on respective PDs in a case of straight-traveling light (circle 101) are references, a surface area for light that is incident on a PD for an illuminance sensor is increased and a surface area for light that is incident on a PD for a proximity sensor is decreased, in a case of oblique light (circle 102). On the other hand, a surface area for light that is incident on a PD for an illuminance sensor is decreased and a surface area for light that is incident on a PD for a proximity sensor is increased, in a case of oblique light (circle 103).

In particular, there is a problem that, as a deviation of amounts of received light is increased between a PD for an illuminance sensor and a PD for spectral sensitivity correction, precision of spectral sensitivity correction to be conducted based on such an amount of received light is degraded.

### SUMMARY OF THE INVENTION

According to one aspect of the present invention, there is provided an optical sensor, including a first light-receiving element with one of a first polygonal ring shape and a first circular ring shape, a second light-receiving element with one of a second polygonal ring shape and a second circular ring shape, the second light-receiving element being provided separately from the first light-receiving element and concentrically with the first light-receiving element, and a subtraction device configured to conduct subtraction between an output from the first light-receiving element and an output from the second light-receiving element.

### BRIEF DESCRIPTION OF THE DRAWINGS

FIG. 1 is a diagram that schematically illustrates one example of a situation of light incident on a semiconductor integrated circuit for an optical sensor according to an embodiment.

FIG. 2 is a diagram that illustrates one example of a configuration of a semiconductor integrated circuit for an optical sensor according to an embodiment.

FIG. 3 is a graph that illustrates one example of a relationship between a voltage and a dark current for a light-receiving element according to an embodiment.

FIG. 4A, FIG. 4B, and FIG. 4C are diagrams that illustrate one example of a configuration of a semiconductor integrated circuit for an optical sensor according to an embodiment.

FIG. 5A and FIG. 5B are diagrams that illustrate one example of a configuration of a semiconductor integrated circuit for an optical sensor according to an embodiment.

FIG. 6A and FIG. 6B are diagrams that illustrate one example of a configuration of a semiconductor integrated circuit for an optical sensor according to an embodiment.

FIG. 7 is a diagram that illustrates one example of a configuration of a semiconductor integrated circuit for an optical sensor according to an embodiment.

FIG. 8 is a diagram that illustrates one example of a configuration of a semiconductor integrated circuit for an optical sensor according to an embodiment.

FIG. 9 is a graph that illustrates one example of a relationship between a wavelength and a relative sensitivity for a light-receiving element according to an embodiment.

FIG. 10 is a diagram that illustrates one example of a spectral characteristic.

FIG. 11A and FIG. 11B are diagrams that illustrate one example of a configuration of a conventional semiconductor integrated circuit for an optical sensor.

### DETAILED DESCRIPTION OF THE PREFERRED EMBODIMENTS

An embodiment of the invention will be described below, with reference to the drawings. In respective drawings, an identical numeral or symbol may be attached to an identical component to omit a redundant description thereof.

In the present specification, a “relative sensitivity” refers to a sensitivity at each wavelength (a wavelength of 400 nm-a wavelength of 1150 nm) in a normalized spectral characteristic provided that a sensitivity of a light-receiving element for an illuminance sensor at a wavelength (a maximum sensitivity) is 100%. Furthermore, in the present specification, a planar shape refers to a shape of an object when viewed from a normal direction of a surface 20s of a light-receiving part 20.

[A Configuration of a Semiconductor Integrated Circuit for an Optical Sensor]

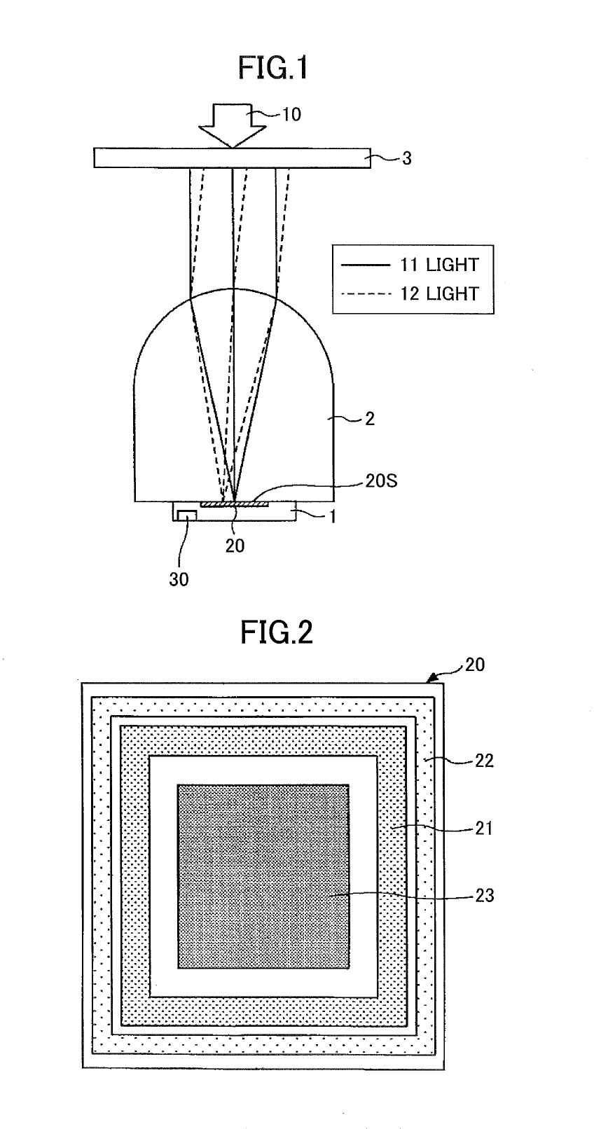

First, one example of a configuration of a semiconductor integrated circuit for an optical sensor according to the present embodiment and a flow from receiving environmental light to detecting an illuminance in such a semiconductor integrated circuit for an optical sensor will simply be described by using FIG. 1.

A semiconductor integrated circuit for an optical Sensor 1 includes a light-receiving part 20 and a spectral sensitivity correction means 30.

Light 10 (environmental light) is incident on the light-receiving part 20 through a cover member 3 and a condenser lens 2. The light-receiving part 20 includes a plurality of light-receiving elements formed on an identical substrate. Each light-receiving element includes a photoelectric conversion part, electrodes, or the like, and an electric current flows therethrough based on an amount of received light. For each light-receiving element, it is possible to use a PN-type photodiode, a PIN-type photodiode, a phototransistor, or the like. Here, an output current of each light-receiving element is a low electric current at a pA order.

Light 11 is light that is incident on a surface 20s of the light-receiving part 20 in a direction perpendicular thereto (and that will be described as straight-travelling light, below) and light 12 is light that is incident on the surface 20s of the light-receiving part 20 in an oblique direction (and that will be described as oblique light, below).

The cover member 3 is used as a cover for hiding the light-receiving part 20, and hence, is formed of a black resin, a black glass, or the like. The cover member 3 attenuates visible light (blocking about 90% thereof) and transmits infrared light therethrough. A thickness, a material, a light blocking rate, or the like, of the cover member 3 is approximately adjusted so that it is possible to change an amount of environmental light to be received by the light-receiving part 20.

The condenser lens 2 condenses light transmitted through the cover member 3. A position of condensed light on the light-receiving part 20 is different between a case where straight-travelling light is incident thereon and a case where oblique light is incident thereon. In either case, it is preferable for a deviation of amounts of received light to be small among a plurality of light-receiving elements formed in the light-receiving part 20. Therefore, it is preferable to adjust a planar shape, arrangement, a surface area, or the like, of each light-receiving element appropriately. A kind of the condenser lens 2 is not particularly limited and it is possible to use a convex lens, a cylindrical lens, or the like.

The spectral sensitivity correction means 30 conducts spectral sensitivity correction based on amounts of received light on (output signals from) a light-receiving element for an illuminance sensor and a light-receiving element for spectral sensitivity correction. Because a planar shape, arrangement, a surface area, or the like, of each light-receiving element is appropriately adjusted in the light-receiving part 20 according to the present embodiment (wherein details thereof will be described later), it is difficult to cause a deviation of amounts of received light between a light-receiving element for an illuminance sensor and a light-receiving element for spectral sensitivity correction even if a direction of light incident on the surface 20 of the light-receiving part 20 is changed. Furthermore, the spectral sensitivity correction means 30 is such that output currents from a light-receiving element for an illuminance sensor and a light-receiving element for spectral sensitivity correction are time-division-AD-converted by an identical AD converter and operationally processed to conduct spectral sensitivity correction. For an operational process, a digital signal that corresponds to an output signal from a light-receiving element for spectral sensitivity correction that has been multiplied by a correction factor is subtracted from a digital signal that corresponds to an output signal from a light-receiving element for an illuminance sensor. A spectral characteristic of a light-receiving element for an illuminance sensor is caused to be close to a predetermined spectral sensitivity characteristic by the spectral sensitivity correction means 30 so that it is possible to improve detection precision of the semiconductor integrated circuit for an optical sensor 1.

[A Configuration of a Light-Receiving Part]

FIG. 2 illustrates one example of a configuration of a light-receiving part 20 that is included in a semiconductor integrated circuit for an optical sensor 1 according to the present embodiment.

The light-receiving part 20 includes a 1st light-receiving element 21, a 2nd light-receiving element 22, and a 3rd light-receiving element 23. As illustrated in FIG. 2, the 1st light-receiving element 21 is a light-receiving element for an illuminance sensor, the 2nd light-receiving element 22 is a light-receiving element for spectral sensitivity correction, and the 3rd light-receiving element 23 is a light-receiving element for a proximity sensor.

An illuminance sensor detects a surrounding brightness based on an amount of environmental light received by the 1st light-receiving element 21. Furthermore, a proximity sensor detects approaching of an object depending on a change in an amount of infrared light received by the 3rd light-receiving element 23. Because a proximity sensor detects weak infrared light that reflects from a moving object, it is preferable for the 3rd light-receiving element 23 to be designed so as to be high-sensitive.

It is preferable for respective light-receiving elements to be formed so as to be separated from one another and have correspondent centers (concentric arrangement). Furthermore, it is preferable for respective light-receiving elements to be formed in such a manner that centers and inside and outside apexes thereof are present on an identical straight line. Here, an arrangement order of respective light-receiving elements is not particularly limited, wherein, for example, the 3rd light-receiving element 23, the 1st light-receiving element 21, and the 2nd light-receiving element 22 may be formed in order from an inside as illustrated in FIG. 2 or may be formed in an order different from that of FIG. 2.

It is preferable for a planar shape of each light-receiving element to be a regular polygonal ring shape, a polygonal shape, a circular ring shape, or a circular shape. Such a polygonal shape is not particularly limited and may be a quadrangular shape, a pentagonal shape, a hexagonal shape, an octagonal shape, or the like. For example, planar shapes of the 1st light-receiving element 21 and the 2nd light-receiving element 22 may be square ring shapes, and a planar shape of the 3rd light-receiving element 23 may be a square shape, as illustrated in FIG. 2.

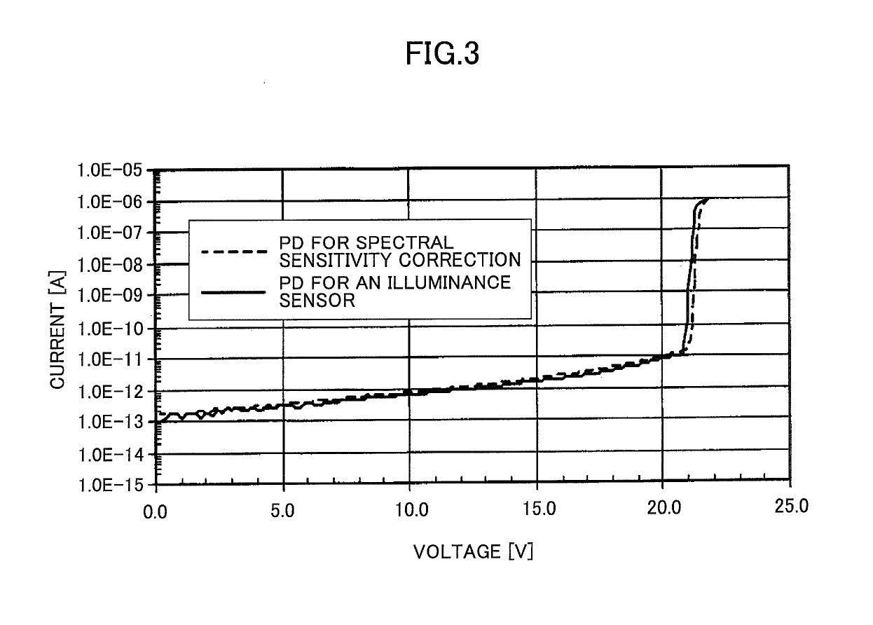

It is preferable for surface areas of respective light-receiving elements to be equal. FIG. 3 illustrates dark current characteristics of a light-receiving element for an illuminance sensor and a light-receiving element for spectral sensitivity correction. That is because dark currents that generate on light-receiving elements with equal surface areas are approximately equal as illustrated in FIG. 3, and hence, it is possible to generally cancel dark currents that generate on respective light-receiving elements, by an operational process that is conducted by a spectral sensitivity correction means 30.

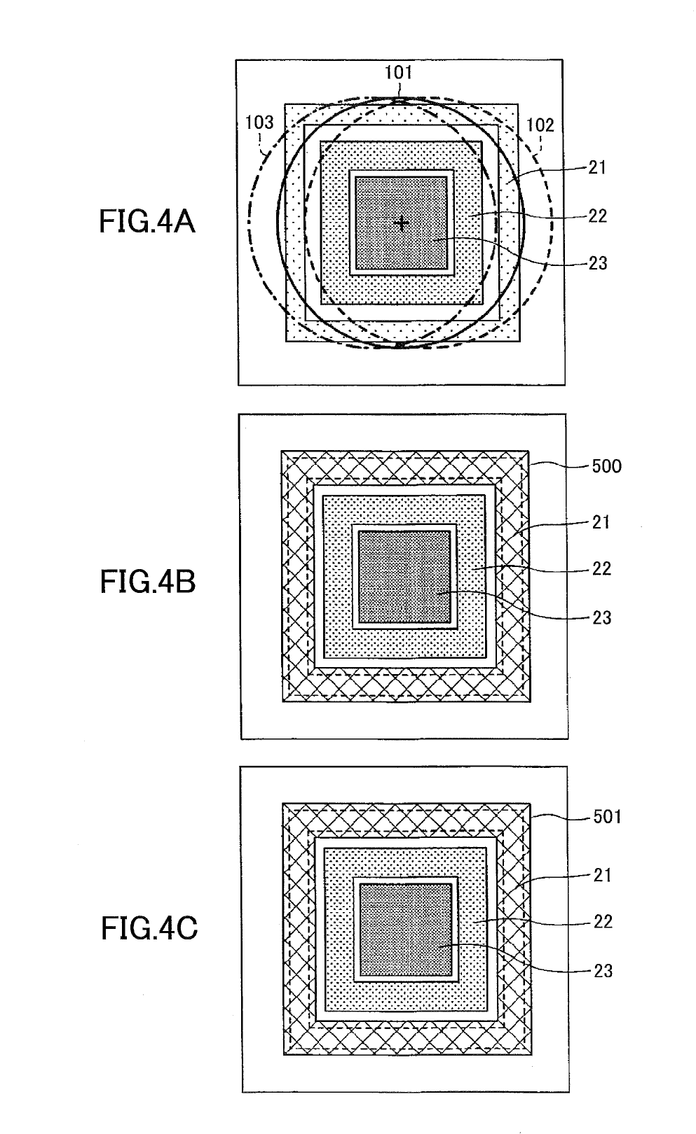

FIG. 4A illustrates a relationship between light incident on a surface 20s of a light-receiving part 20 and an amount of received light for each light-receiving element. A circle 101 represents straight-travelling light and a circle 102 and a circle 103 represent oblique light.

In FIG. 4A, planar shapes of a 1st light-receiving element 21 and a 2nd light-receiving element 22 are approximately quadrangular ring shapes and the 1st light-receiving element 21 and the 2nd light-receiving element 22 are separated from each other and arranged concentrically. As a surface area for light that is incident on the 1st light-receiving element 21 in a case of FIG. 4A is considered, the circle 101>the circle 102=the circle 103 is provided. That is, as a surface area for light that is incident on the 1st light-receiving element 21 in a case of the circle 101 is a reference, surface areas for light in cases of the circle 102 and the circle 103 are decreased and amounts of decreases thereof are approximately identical. Briefly, amount of decreases of surface areas for light are approximately identical in both a case where a position of a spot is shifted as the circle 102 due to oblique light and a case where a shift is caused as the circle 103. The 2nd light-receiving element 22 is also similar thereto. Therefore, it is possible to generally homogenize amounts of received light between the 1st light-receiving element 21 and the 2nd light-receiving element 22 (it is possible to mitigate a variation of a rate of amounts of received light on both elements in a case of oblique light).

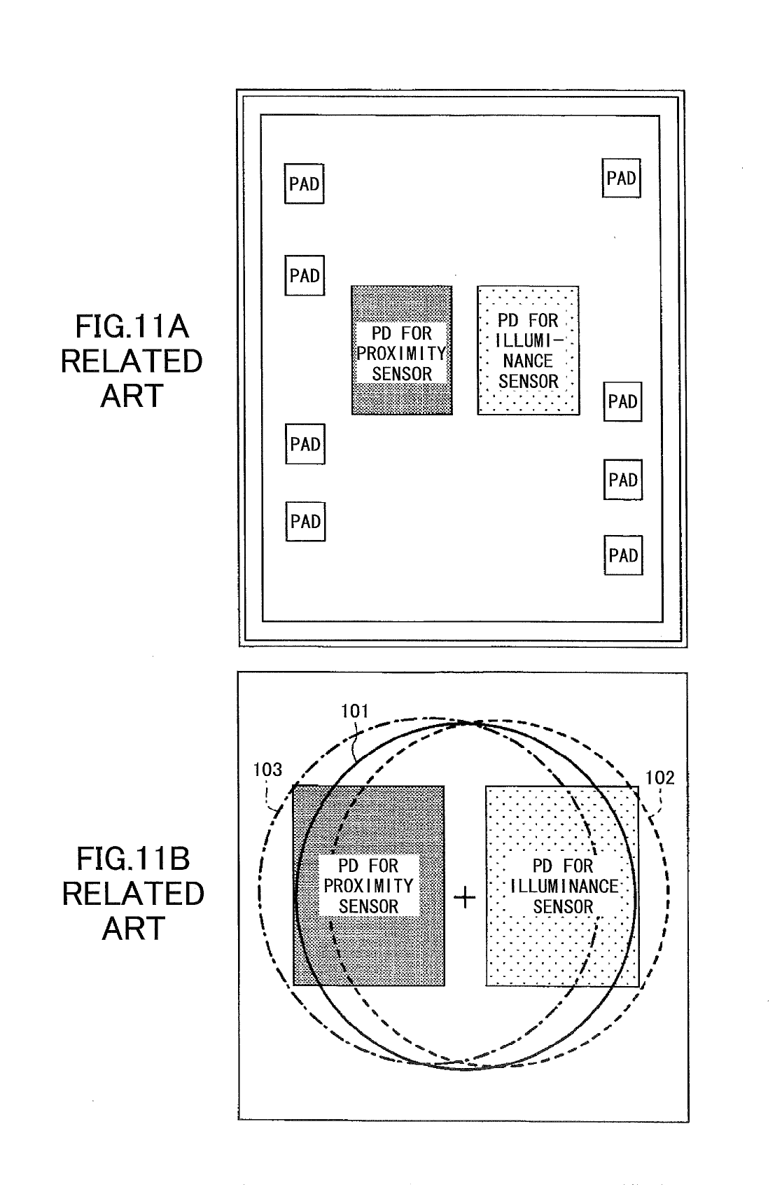

Herein, as FIG. 11B is referred to again and a surface area for light that is incident on a PD for an illuminance sensor is considered, a circle 102>a circle 101 is provided. Furthermore, in a case where a position of a spot is shifted to an opposite side of the circle 102 with respect to the circle 101 due to oblique light (this case is defined as a circle 103), the circle 101>the circle 103 is provided. That is, as a surface area for light that is incident on a PD for an illuminance sensor in a case of the circle 101 is a reference, a surface area for light in a case of the circle 102 is increased and a surface area for light is decreased in a case of the circle 103. Briefly, in a case where a position of a spot is shifted due to oblique light, a surface area for light is increased or decreased relative to the reference depending on a direction of such shift and a range of a deviation of surface areas for light is increased (a range of a deviation of amounts of received light is increased). A PD for a proximity sensor is also similar thereto.

On the other hand, in the present embodiment (see FIG. 4A), a surface area for light is not increased in both a case where a position of a spot is shifted as the circle 102 due to oblique light and a case where a shift is caused as the circle 103 but surface areas for light are decreased by an approximately identical amount, as described above. Hence, it is possible to suppress a deviation of surface areas for light depending on a shift direction even in a case where a position of a spot is shifted due to oblique light, as compared to a conventional example illustrated in FIG. 11A and FIG. 11B (it is possible to suppress a deviation of amounts of received light).

Thus, planar shapes of the 1st light-receiving element 21 and the 2nd light-receiving element 22 are approximately quadrangular ring shapes and the 1st light-receiving element 21 and the 2nd light-receiving element 22 are separated from each other and arranged concentrically so that it is possible to suppress a deviation of surface areas for light depending on a shift direction even in a case where a position of a spot is shifted due to oblique light (it is possible to suppress a deviation of amounts of received light).

The 1st light-receiving element 21 has a 1st spectral characteristic. A 1st spectral characteristic has a high relative sensitivity in a visible light region. A 1st spectral characteristic has, for example, a maximum sensitivity at a wavelength of about 550 nm and a low relative sensitivity at a wavelength of about 800 nm.

As illustrated in FIG. 4B, it is preferable to form an infrared light cut filter (1st filter) 500 so as to cover a 1st light-receiving element 21. An infrared light cut filter transmits visible light and attenuates infrared light. Such a filter is formed so that it is possible to decrease a relative sensitivity in an infrared light region in a 1st spectral characteristic.

A 3rd light-receiving element 23 has a 2nd spectral characteristic. A 2nd spectral characteristic has a high relative sensitivity in an infrared light region.

As illustrated in FIG. 4C, it is preferable to form a visible light cut filter (2nd filter) 501 so as to cover a 3rd light-receiving element 23. A visible light cut filter transmits infrared light and attenuates visible light.

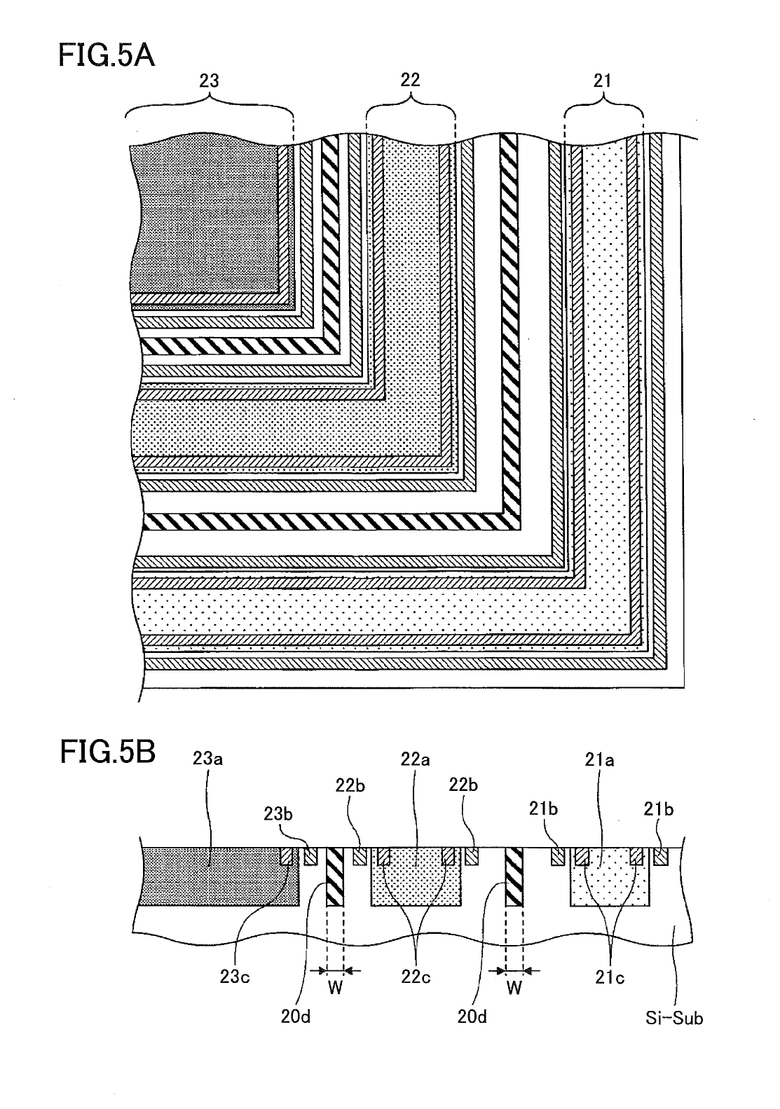

FIG. 5A and FIG. 5B are enlarged views of a light-receiving part 20. A 1st light-receiving element 21 includes a photoelectric conversion part 21a, an anode electrode 21b, and a cathode electrode 21c. A 2nd light-receiving element 22 includes a photoelectric conversion part 22a, an anode electrode 22b, and a cathode electrode 22c. A 3rd light-receiving element 23 includes a photoelectric conversion part 23a, an anode electrode 23b, and a cathode electrode 23c.

A separation part 20d separates and insulates respective light-receiving elements from one another. It is preferable for a planar shape of the separation part 20d to be a shape that corresponds to planar shapes of respective light-receiving elements so that it is possible to separate respective light-receiving elements efficiently. It is possible to adjust a space between separation parts 20d appropriately.

It is preferable for the photoelectric conversion parts 21a, 22a, and 23a to be formed so as to include semiconductor materials that have different spectral characteristics. It is preferable for the photoelectric conversion part 21a to be formed of a semiconductor material that has a maximum sensitivity in a visible light region and for the photoelectric conversion parts 22a and 23a to be formed of semiconductor materials that have a maximum sensitivity in an infrared light region. A thickness, a composition ratio, a band gap energy, an impurity concentration, or the like, of a photoelectric conversion part is changed depending on an application thereof so that it is possible to adjust a spectral characteristic appropriately.

### Variation Example 1

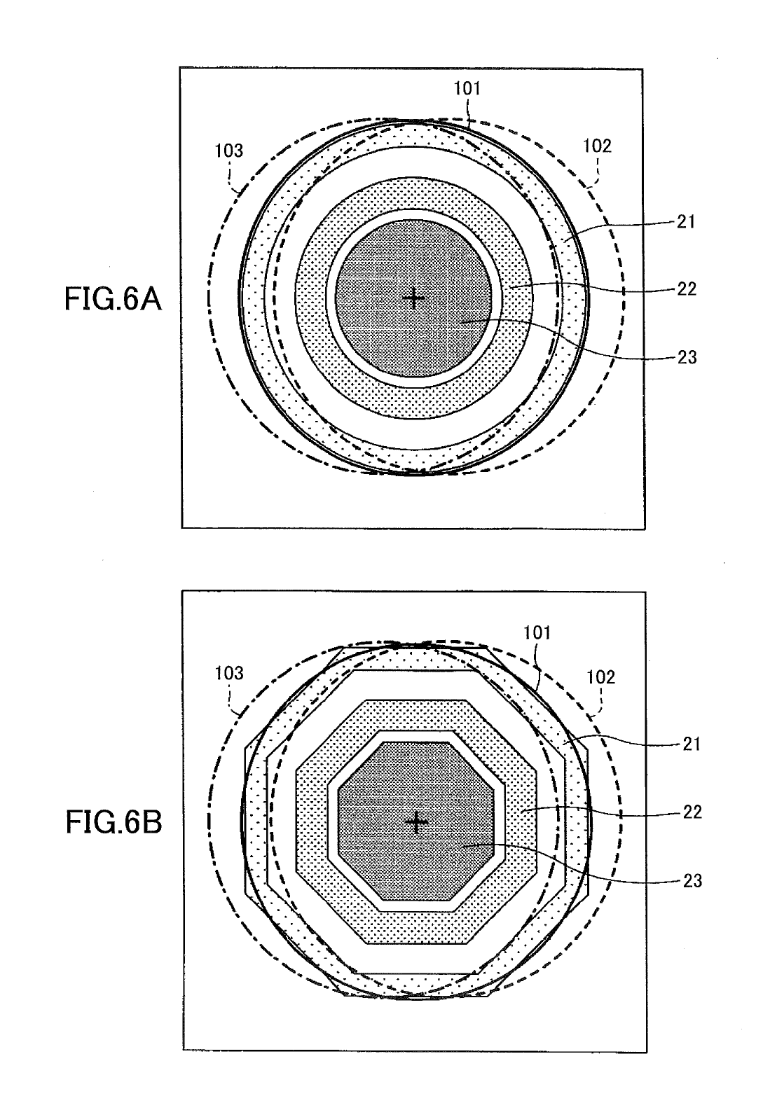

FIG. 6A illustrates a relationship between light incident on a surface 20a of a light-receiving part 20 and an amount of received light for each light-receiving element. A circle 101 represents straight-travelling light and a circle 102 and a circle 103 represent oblique light.

In FIG. 6A, planar shapes of a 1st light-receiving element 21 and a 2nd light-receiving element 22 are approximately circular ring shapes and a planar shape of a 3rd light-receiving element 23 is an approximately circular shape, wherein the 1st light-receiving element 21, the 2nd light-receiving element 22, and the 3rd light-receiving element 23 are separated from one another and arranged concentrically. Here, surface areas of respective light-receiving elements are approximately equal.

As a surface area for light that is incident on the 1st light-receiving element 21 in a case of FIG. 6A is, considered, the circle 101>the circle 102=the circle 103 is provided. That is, as a surface area for light that is incident on the 1st light-receiving element 21 in a case of the circle 101 is a reference, surface areas for light in cases of the circle 102 and the circle 103 are decreased and amounts of decreases thereof are approximately identical. Briefly, amounts of decreases of surface areas for light are approximately identical in both a case where a position of a spot is shifted as the circle 102 due to oblique light and a case where a shift is caused as the circle 103. An amount of a decrease in a case of FIG. 6A is less than an amount of a decrease in a case of FIG. 4A.

Hence, it is possible for surface areas for light that is incident on all of light-receiving elements (the 1st light-receiving element 21, the 2nd light-receiving element 22, and the 3rd light-receiving element 23) to be approximately equal (it is possible to generally homogenize amounts of received light among light-receiving elements) even in a case where a position of a spot is shifted due to oblique light.

### Variation Example 2

FIG. 6B illustrates a relationship between light incident on a surface 20a of a light-receiving part 20 and an amount of received light for each light-receiving element. A circle 101 represents straight-travelling light and a circle 102 and a circle 103 represent oblique light.

In FIG. 6B, a planar shape of a 1st light-receiving element 21 is an approximately octagonal ring shape.

As a surface area for light that is incident on the 1st light-receiving element 21 in a case of FIG. 6B is considered, the circle 101>the circle 102=the circle 103 is provided. That is, as a surface area for light that is incident on the 1st light-receiving element 21 in a case of the circle 101 is a reference, surface areas for light in cases of the circle 102 and the circle 103 are decreased and amounts of decreases thereof are approximately identical. Briefly, amounts of decreases of surface areas for light are approximately identical in both a case where a position of a spot is shifted as the circle 102 due to oblique light and a case where a shift is caused as the circle 103. An amount of a decrease in a case of FIG. 6B is greater than an amount of a decrease in a case of FIG. 6A but is less than an amount of a decrease in a case of FIG. 4A.

A ratio of concentric polygonal shapes that are octagonal shapes (a circumscribed circle radius/an inscribed circle radius) is 1/cos(π/8)=1/{(√(2+√2))/2)}. Therefore, an error produced between a distance from a center to a vertex (a point that is furthest from the center) and a distance from the center to a center of each side (a point that is nearest from the center) is within 8.2%. Because a ratio of concentric polygonal shapes that are square shapes is √2, the number of sides of polygonal shapes are increased so that it is possible to better suppress a deviation of surface areas for light depending on a shift direction even in a case a position of a spot is shifted due to oblique light.

Here, in a case where a planar shape of a light-receiving element is an approximately polygonal ring shape, a portion of a surface area may be cut at an outside corner portion of a polygonal shape and a surface area of a cut portion may be added to an inside corner portion. Such a planar shape is provided so that, for example, in a case of the circle 101, it is possible to cause a surface area for light that is incident on the 1st light-receiving element in FIG. 4A and FIG. 6B to be close to a surface area for light that is incident on the 1st light-receiving element 21 in FIG. 6A.

[A Spectral Sensitivity Correction Means]

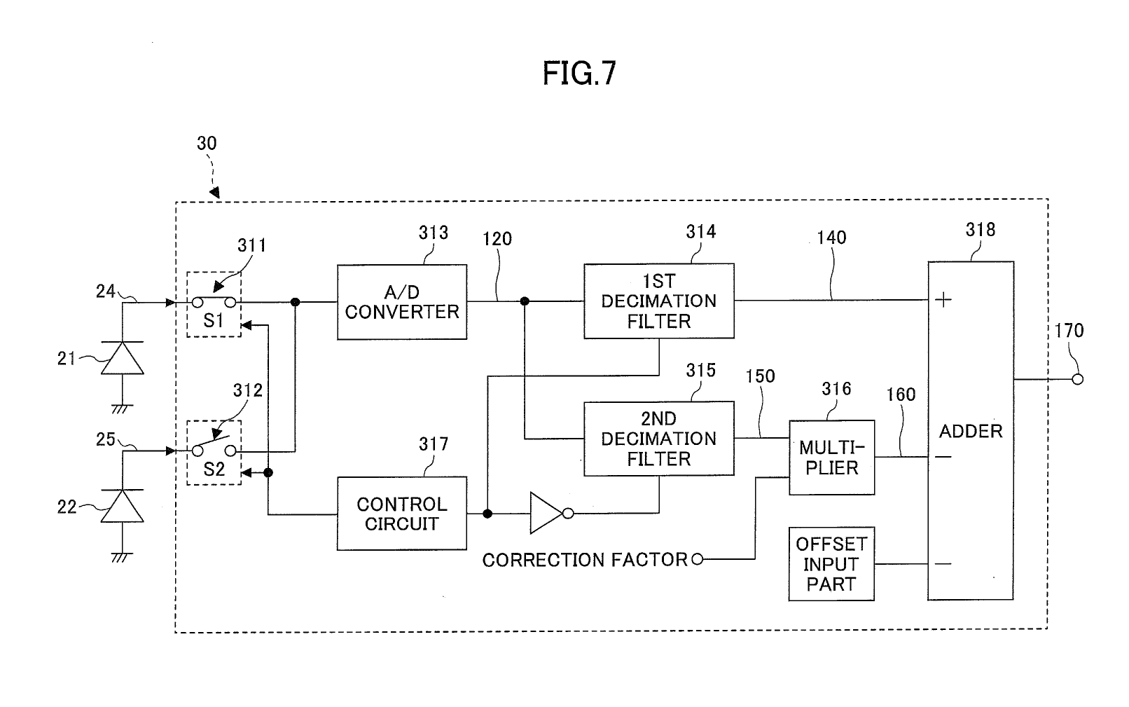

FIG. 7 illustrates one example of a spectral sensitivity correction means 30 that is included in a semiconductor integrated circuit for an optical sensor 1 according to the present embodiment.

The spectral sensitivity correction means 30 includes a switch circuit 311, a switch circuit 312, an AD converter 313, a 1st decimation filter 314 (for an illuminance sensor), a 2nd decimation filter 315 (for spectral sensitivity correction), a multiplier 316, a control circuit 317, and an adder 318.

The spectral sensitivity correction means 30 is such that input signals 24 and 25 are time-division-AD-converted by the AD converter 313, decimated by the decimation filters 314 and 315, and operationally processed by the multiplier 316 and the adder 318 so that an output signal 170 is outputted.

The switch circuit 311 conducts switching between input and non-input of the input signal 24 from a 1st light-receiving element 21 into the AD converter 313. Switching on or off of the switch circuit 311 is controlled by the control circuit 317. For example, when the switch circuit 311 is turned on, the input signal 224 is inputted into the AD converter 313.

The switch circuit 312 conducts switching between input and non-input of the input signal 25 from a 2nd light-receiving element 22 into the AD converter 313. Switching on or off of the switch circuit 312 is controlled by the control circuit 317. For example, when the switch circuit 312 is turned on, the input signal 25 is inputted into the AD converter 313.

The control circuit 317 controls each switch circuit in such a manner that timing of turning on (or off) of the switch circuit 311 and timing of turning on (or off) of the switch circuit 312 are not coincident.

The AD converter 313 (AD conversion part) is, for example, a 16-bit ΔΣ-type AD converter wherein AD conversion is conducted by utilizing ΔΣ modulation. Specifically, the AD converter 313 AD-converts the input signals 24 and 25 in synchronization with timing of switching on or off of the switch circuit 311 or 312 so that an output signal 120 (digital signal) is produced. In other words, the AD converter 313 time-division-AD-converts the input signal 24 that is an output from the 1st light-receiving element 21 and the input signal 25 that is an output from the 2nd light-receiving element 22 so that the output signal 120 (digital signal) is produced. Furthermore, the AD converter 313 inputs the output signal 120 into the 1st decimation filter 314 and the 2nd decimation filter 315.

The 1st decimation filter 314 decimates the output signal 120 so that a signal 140 (digital signal) is produced that corresponds to an output current from the 1st light-receiving element 21. Furthermore, the signal 140 is inputted into the adder 318 that is an operation part. The 2nd decimation filter 315 decimates the output signal 120 so that a signal 150 (digital signal) is produced that corresponds to an output current from the 2nd light-receiving element 22. Furthermore, the signal 150 is inputted into the multiplier 316. Because two input signals are time-division-AD-converted by an identical AD converter, a little or no conversion error is produced between the signal 140 and the signal 150. Here, it is also possible for a decimation filter to eliminate a noise that is generated in the output signal 120 or the like.

An operation or a non-operation of the 1st decimation filter 314 or the 2nd decimation filter 315 is controlled by the control circuit 317.

The multiplier 316 multiplies the signal 150 by a correction factor so that a signal 160 (digital signal) is produced. Here, the signal 160 is an inverted signal of the signal 150 multiplied by a correction factor, because the multiplier 316 is provided with an inversion circuit (inverter).

The adder 318 conducts addition (substantially subtraction) between the signal 140 and the signal 160 so that an output signal 170 (digital signal) is produced.

Briefly, the signal 160 with a multiplied correction factor that corresponds to an output current from the 2nd light-receiving element 22 that is a light-receiving element for spectral sensitivity correction is subtracted from the signal 140 that corresponds to an output current from the 1st light-receiving element 21 that is a light-receiving element for an illuminance sensor. Thereby, it is possible to provide a low relative sensitivity of the 1st light-receiving element 21 in an infrared light region.

Here, the adder 318 may be provided with an offset input part in such a manner that it is possible to cancel dark current by inputting an offset from the offset input part in a case where it is not possible for an operational process in the spectral sensitivity correction means 30 to cancel such dark current completely, or the like.

It is possible to represent operational processes of the multiplier 316 and the adder 318 by the following formula:

(signal 140)−{(correction factor)×(signal 150}{=(signal 160)}1=(output signal 170).

Here, the spectral sensitivity correction means 30 may include a correction factor setting circuit for arbitrarily setting a correction factor, a correction factor selection circuit for appropriately selecting a set correction factor, or the like (not-illustrated). It is preferable to use these circuits so that a correction factor is appropriately adjusted depending on conditions.

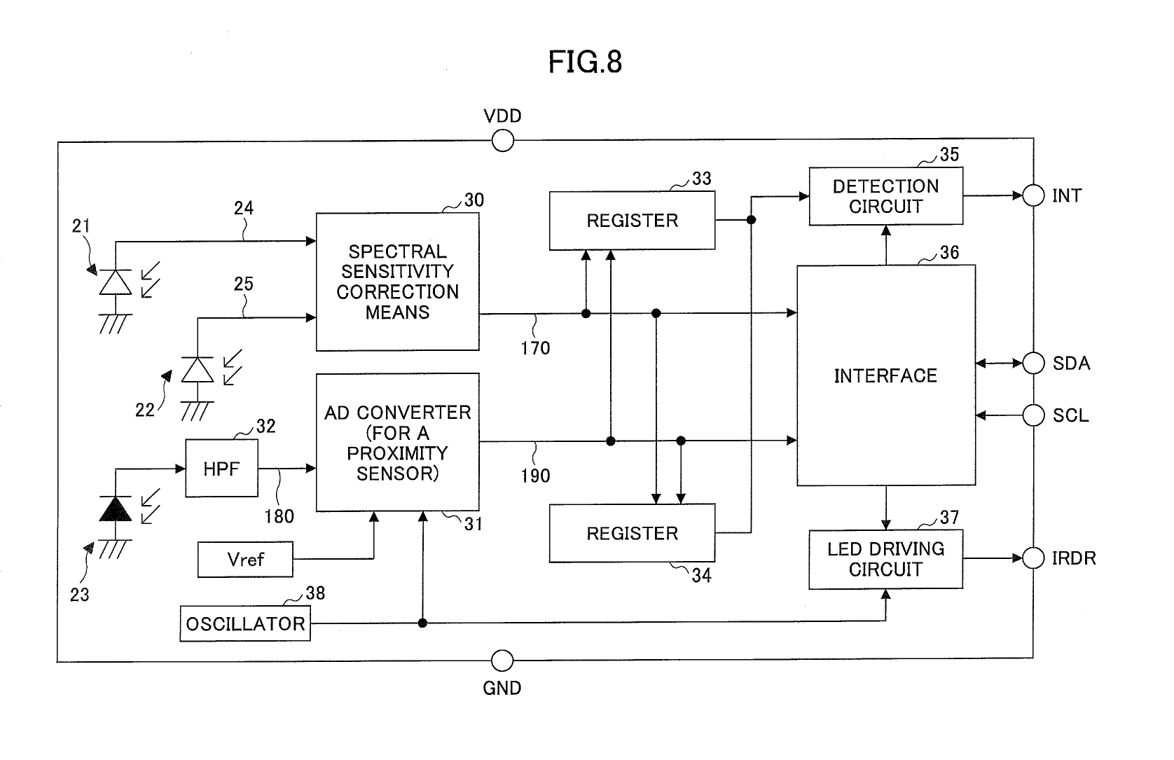

Herein, a circuit other than a spectral sensitivity correction means 30 that is included in a semiconductor integrated circuit for an optical sensor 1 will simply be described by using FIG. 8. The semiconductor integrated circuit for an optical sensor 1 includes an AD converter 31 (for a proximity sensor), a high-pass filter (HPF) 32, registers 33 and 34, a detection circuit 35, an interface 36, an LED driving circuit 37, an oscillator 38, or the like, other than the spectral sensitivity correction means 30.

The high-pass filter 32 removes a direct current component from an output current of a 3rd light-receiving element 23 to derive only an alternating current component and produce a signal 180.

The AD converter 31 utilizes a pulsed signal that is outputted from the oscillator 38 and a reference voltage Vref to AD-convert the signal 180 and produce an output signal 190 (digital signal).

The registers 33 and 34 are setting registers capable of writing an arbitrary value therein, wherein an upper limit threshold value is written in the register 33 and a lower limit threshold value is written in the register 34. Here, it is preferable for an upper limit threshold value and a lower limit threshold value to be set properly depending on conditions.

The detection circuit 35 detects whether or not an output signal 170 or an output signal 190 is provided over an upper limit threshold value, based on a setting value for the register 33. That is, the detection circuit 35 outputs a signal in such a manner that an INT terminal is at “High” when the output signal 170 is provided over an upper limit threshold value and a signal in such a manner that the INT terminal is at “Low” when the output signal 170 is not provided over the upper limit threshold value.

Furthermore, the detection circuit 35 detects whether or not the output signal 170 or the output signal 190 is provided under a lower limit threshold value, based on a setting value for the register 34. That is, the detection circuit 35 outputs a signal in such a manner that an INT terminal is at “High” when the output signal 170 is provided under a lower limit threshold value and a signal in such a manner that the INT terminal is at “Low” when the output signal 170 is not provided under the lower limit threshold value.

The interface 36 conducts intercommunication with an external instrument through an SDA terminal or an SCL terminal and the semiconductor integrated circuit for an optical sensor 1 that includes the spectral sensitivity correction means 30, the AD converter 31, and the like. Furthermore, it is also possible for the interface 36 to install information from an external instrument.

For example, the spectral sensitivity correction means 30 may be connected to a CPU or the like through a predetermined interface (for example, I²C bus or the like) so that it is possible to conduct setting or selection of a correction factor through the CPU or the like. In this case, it is possible for a CPU or the like to realize a correction factor setting means. A correction factor setting means may be realized by software or may be realized by hardware or may include both of them. Furthermore, for example, it is also possible to transmit a detection result of environmental light being too bright, an object being approaching thereto, or the like, through an interface to an external instrument and it is also possible to appropriately control the detection circuit 35, the LED driving circuit 37, or the like, based on information acquired from an external instrument.

The LED driving circuit 37 produces an LED control signal based on a control signal outputted from the interface 36 and controls driving (emission or non-emission) of an infrared ray LED through an IRDR terminal. A proximity sensor detects approaching of an object in such a manner that, when an output emitted from an infrared ray LED is reflected from such an object, presence or absence of reflected light is detected. Hence, timing of driving of the LED driving circuit 37 and timing of AD conversion in the AD converter 31 are needed to be simultaneously controlled by, for example, the oscillator 38 or the like. Here, timing of AD conversion in the spectral sensitivity correction means 30 and timing of driving of the LED driving circuit 37 are controlled separately.

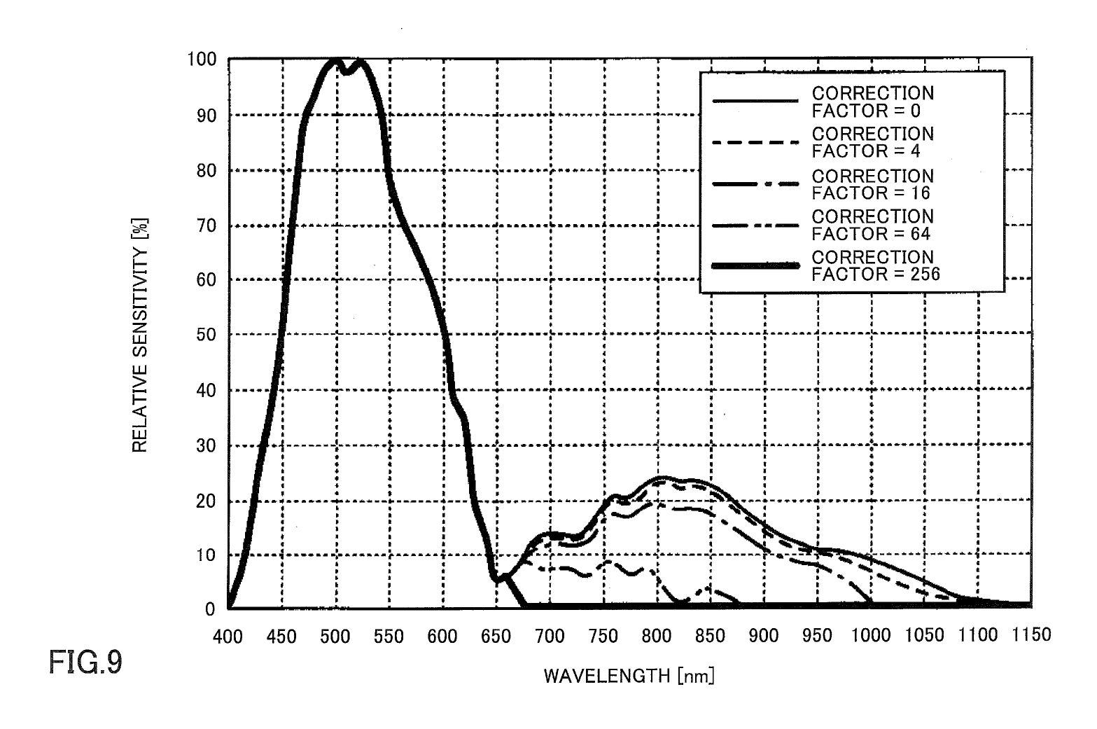

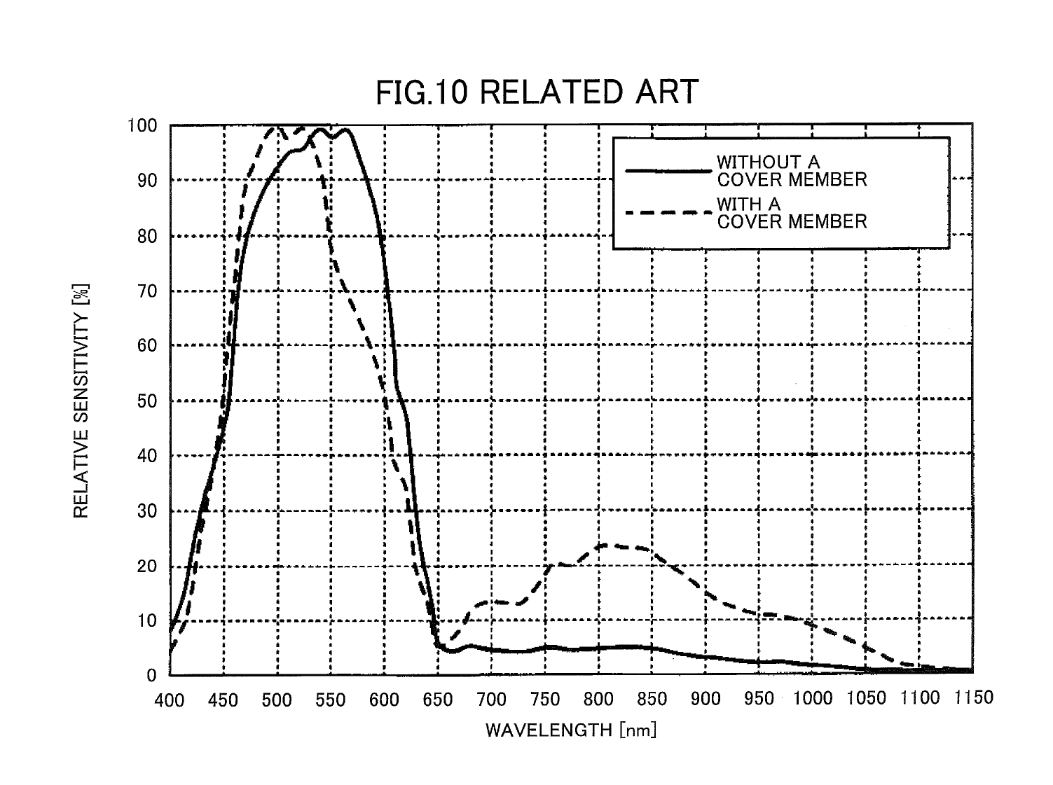

FIG. 9 is a graph that illustrates a relationship between a wavelength and a relative sensitivity of a 1st light-receiving element 21 covered with a cover member 3 in a case where a correction factor is changed to be 0, 4, 16, 64, or 256. A transverse axis is provided for a wavelength [nm] (a wavelength of 400 nm-a wavelength of 1150 nm) and a longitudinal axis is provided for a relative sensitivity [%].

It is possible to understand that a relative sensitivity in an infrared light region is decreased as a correction factor is increased. For example, a relative sensitivity of about 25% at a correction factor of 0, a relative sensitivity of about 8% at a correction factor of 64, and a relative sensitivity of about 0% at a correction factor of 256 are provided in a case where a wavelength is 800 [nm].

That is, it is possible to understand that it is possible to control a relative sensitivity in an infrared light region by changing a correction factor. Here, a relative sensitivity of the 1st light-receiving element 21 that is a bare chip (wherein a light-receiving part 20 is not covered with a cover member 3) is about 5% in a case where a wavelength is 800 [nm] and a correction factor is 0. As a light-receiving part 20 is covered with a cover member 3, a relative sensitivity in an infrared light region is increased.

Thus, planar shapes, arrangement, surface areas, or the like, of a plurality of light-receiving elements are adjusted and formed in a semiconductor integrated circuit for an optical sensor according to the present embodiment so that it is possible to homogenize amounts of received light among respective light-receiving elements even if a direction of light incident on a surface of a light-receiving part is changed. Therefore, it is possible to realize a semiconductor integrated circuit for an optical sensor wherein precision of spectral sensitivity correction in an illuminance sensor is improved and precision of detection in a proximity sensor is maintained.

Although a preferable embodiment of the present invention has been described above in detail, the present invention is not limited to such a specific embodiment and it is possible to conduct a variety of alterations or modifications within the scope of the spirit of an embodiment of the present invention as described in what is claimed.

### APPENDIX

### An Illustrative Embodiment(s) of a Semiconductor Integrated Circuit for an Optical Sensor

At least one illustrative embodiment of the present invention relates to a semiconductor integrated circuit for an optical sensor.

At least one illustrative embodiment of the present invention is provided by taking a problem described above into consideration and aims at providing a semiconductor integrated circuit for an optical sensor that conducts spectral sensitivity correction at high precision.

A semiconductor integrated circuit for an optical sensor according to at least one illustrative embodiment of the present invention is required to be a semiconductor integrated circuit for an optical sensor (1) that receives environmental light via a cover member (3) that attenuates visible light and transmits infrared light and a condenser lens (2), conducts spectral sensitivity correction based on an amount of received light, and detects an illuminance for the environmental light, which has a 1st light receiving element (21) that has a 1st spectral characteristic, a 2nd light-receiving element (22), and a spectral sensitivity correction means (30) that conducts subtraction between an output from the 1st light-receiving element (21) and an output from the 2nd light-receiving element (22), wherein planar shapes of the 1st light-receiving element (21) and the second light-receiving element (22) are approximately polygonal ring shapes and wherein the 1st light-receiving element (21) and the 2nd light-receiving element (22) are separated from each other and arranged concentrically.

Here, a reference numeral in parentheses described above is accompanied to facilitate understanding and is merely one example, so that no limitation to an illustrated embodiment is provided.

Illustrative Embodiment (1) is a semiconductor integrated circuit that receives environmental light via a cover member that attenuates visible light and transmits infrared light and a condenser lens, conducts spectral sensitivity correction bases on an amount of received light, and detects an illuminance for the environmental light, wherein the semiconductor integrated circuit for an optical sensor is characterized by having a 1st light-receiving element that has a 1st spectral characteristic, a 2nd light-receiving element, and a spectral sensitivity correction means that conducts subtraction between an output from the 1st light-receiving element and an output from the 2nd light-receiving element, wherein planar shapes of the 1st light-receiving element and the 2nd light-receiving element are approximately polygonal ring shapes and wherein the 1st light-receiving element and the 2nd light-receiving element are separated from each other and arranged concentrically.

Illustrative Embodiment (2) is the semiconductor integrated circuit for an optical sensor as described in Illustrative Embodiment (1), characterized in that the 1st spectral characteristic is obtained by a 1st filter that transmits visible light.

Illustrative Embodiment (3) is the semiconductor integrated circuit for an optical sensor as described in Illustrative Embodiment (1) or Illustrative Embodiment (2), characterized in that the spectral sensitivity correction means includes a multiplier that multiplies an output from the 2nd light-receiving element by a correction factor and a correction factor setting means that sets the correction factor.

Illustrative Embodiment (4) is the semiconductor integrated circuit for an optical sensor as described in any one of Illustrative Embodiment (1) to Illustrative Embodiment (3), characterized in that surface areas of the 1st light-receiving element and the 2nd light-receiving element are approximately equal.

Illustrative Embodiment (5) is the semiconductor integrated circuit for an optical sensor as described in any one of Illustrative Embodiment (1) to Illustrative Embodiment (4), characterized in that planar shapes of the 1st light-receiving element and the 2nd light-receiving element are approximately circular ring shapes.

Illustrative Embodiment (6) is the semiconductor integrated circuit for an optical sensor as described in any one of Illustrative Embodiment (1) to Illustrative Embodiment (5), characterized by having a 3rd light-receiving element that has a 2nd spectral characteristic, wherein the 3rd light-receiving element is arranged inside with respect to the 1st light-receiving element and the 2nd light-receiving element.

Illustrative Embodiment (7) is the semiconductor integrated circuit for an optical sensor as described in Illustrative Embodiment (6), characterized in that the 2nd light-receiving element and the 3rd light-receiving element are arranged adjacently.

Illustrative Embodiment (8) is the semiconductor integrated circuit for an optical sensor as described in Illustrative Embodiment (6) or Illustrative Embodiment (7), characterized in that a planar shape of the 3rd light-receiving element is an approximately square shape.

According to at least one illustrative embodiment of the present invention, it is possible to provide a semiconductor integrated circuit for an optical sensor that conducts spectral sensitivity correction at high precision.

Although the illustrative embodiments and specific examples of the present invention have been described with reference to the accompanying drawings, the present invention is not limited to any of the illustrative embodiments and specific examples, and the illustrative embodiments and specific examples may be altered, modified, or combined without departing from the scope of the present invention.

In regard to the present application, the entire contents of Japanese Patent Application No. 2013-158407 filed on Jul. 31, 2013 in Japan are hereby incorporated by reference herein.

What is claimed is:

1. An optical sensor, comprising:
a first light-receiving element with one of a first polygonal ring shape and a first circular ring shape;
a second light-receiving element with one of a second polygonal ring shape and a second circular ring shape, the second light-receiving element being provided separately from the first light-receiving element and concentrically with the first light-receiving element; and
a subtraction device configured to conduct subtraction between an output from the first light-receiving element and an output from the second light-receiving element.

2. The optical sensor as claimed in claim 1, further comprising:
a filter configured to cover one of the first light-receiving element and the second light-receiving element and transmit visible light.

3. The optical sensor as claimed in claim 1, further comprising:
a multiplier configured to multiply one of an output from the first light-receiving element and an output from the second light-receiving element by a correction factor; and
a correction factor setting part configured to set the correction factor.

4. The optical sensor as claimed in claim 1, wherein a surface area of the first light-receiving element and a surface area of the second light-receiving element are equal to each other.

5. The optical sensor as claimed in claim 1, further comprising:
a third light-receiving element provided inside the first light-receiving element and the second light-receiving element.

6. The optical sensor as claimed in claim 5, wherein the third light-receiving element is adjacent to one of the first light-receiving element and the second light-receiving element.

7. The optical sensor as claimed in claim 5, wherein the third light-receiving element has one of a polygonal shape and a circular shape.
